(19) United States
(12) Patent Application Publication
(10) Pub. No.: US 2009/0294303 A1
(43) Pub. Date: Dec. 3, 2009

(54) method for identifying compounds that affect a transport of a protein through menbrane trafficking pathway

(75) Inventors: Rainer Fischer, Monschau (DE); Neil Emans, Thimister-Clermont (BE); Stefano Di Fiore, Neuss (DE); Carlo Jochems, Köln (DE); Kurt Herrenknecht, Hamburg (DE); Stephan Hurling, Hamburg (DE)

Correspondence Address: VENABLE LLP, P.O. BOX 34385, WASHINGTON, DC, 20043-9998, US

(73) Assignee: THE REGENTS OF THE UNIVERSITY OF CALIFORNIA, Oakland, CA (US)

(21) Appl. No.: 11/665,219

(22) PCT Filed: Oct. 12, 2005
(86) PCT No.: PCT/US05/36671

§ 371 Date: Jul. 2, 2009

Related U.S. Application Data
(60) Provisional application No. 60/618,421, filed on Oct. 12, 2004.

(51) Int. Cl. G01N 27/403; B29C 41/20

(52) U.S. Cl. 205/780.5; 204/403.01; 264/450; 977/762

(57) ABSTRACT

Resistive-sensors are provided wherein networks or nanoframeworks of conducting polymer nanowires are electrochemically grown from pre-polymer solutions in the junction gap located between electrode pairs.

### BACKGROUND OF THE INVENTION

1. Field of the Invention

The present invention relates generally to sensors that utilize an electrode pair in combination with a sensing element. More particularly, the present invention involves sensors wherein nanostructured materials are used to make up all or part of the sensing element.

2. Description of Related Art

Recent developments in the design and synthesis of conducting one-dimensional (1-D) nanostructured materials, including carbon nanotubes, metal- and/or oxide-based nanowires, and polymer nanowires, have attracted much attention across scientific and engineering disciplines. These 1-D materials have become prime candidates for replacing conventional bulk materials in micro- and nanoelectronic devices and chemical and biological sensors. Although many examples have been demonstrated of workable devices and sensors based on 1-D nanostructured materials, it remains a challenge to discover efficient, scalable, and site-specific approaches for incorporating these 1-D nanomaterials into lithographically patterned electrode junctions.

The simplest configuration of an electronic sensor is a resistive junction composed of two solid-state electrodes between which is sandwiched a conducting material. The transport properties of the sensor change upon exposure of the junction to analytes, as a result of doping/dedoping interactions of the analyte molecules with the chemical building blocks of the conducting material. By applying a constant bias across this junction, the presence of analytes can be detected simply by monitoring the conducting current. In this text, the terms “analyte” and “test medium” are used interchangeably.

In recent years, conducting polymer-based nanostructured materials in the shapes of thin films and nanowires have been utilized extensively in resistive sensors because of their promising properties, which include high surface areas, chemical specificities, tunable conductivities, material flexibilities, and easy processing. For example, (i) polyaniline nanowires that have been obtained through a facile synthesis or by an electrospinning method have been incorporated into interdigitated electrodes to obtain gas phase sensors that have excellent sensitivity, (ii) template-directed electrochemical processes have been employed to fabricate nanowire junctions that feature robust polymer-electrode contacts, and (iii) mechanical stretching and magnetic field-assisted assembly have produced miniaturized polymer-electrode junctions.

Despite the successes of the above fabrication methods for preparing micro- and nanoscale sensors that incorporate conducting polymer-based nanostructured materials, there are certain limitations in terms of device yields, potential for further miniaturization, scalability, and fabrication costs that prohibit sequential developments of these types of resistive sensors. In addition, to date, most resistive sensors have been employed only for the detection of analytes in the gas phase. The ability to harness the promising properties of conducting polymer-based nanostructured materials for the development of resistive sensors that function in solution will open up new opportunities to revolutionize many conventional analytical techniques.

The transporting properties of conducting polymer nanowires have been studied mostly in the context of two-terminal devices. Very few examples of three-terminal devices based on these nanowires have been reported. A three-terminal device, i.e., a field effect transistor (FET) is composed of drain, source, and gate electrodes. The FET provides an excellent platform for in-depth investigations of gating and doping effects, the nature of the doping, field induced charge mobility and the field-induced modulation (on/off current ratio) of conducting materials.

Although conducting polymer nanowires have rarely been studied using a three-terminal device, other 1-dimensional nanostructured materials, e.g., carbon nanotubes and metal- and oxide-based nanowires have been studied extensively on FET platforms and subsequently harnessed for applications in nanoscale devices.

Electrolyte-gated transistors can be made by introducing a remote gate electrode into the surrounding electrolyte solution. Such electrolyte-gated transistors have been utilized widely for chemo- and sensing purposes because the gate-induced modulation provides another dimension of information in addition to the transport (I-V) characteristics obtained by two-terminal devices. Moreover, gate-induced modulation can be applied for signal amplification to enhance the detection performance of resistive sensors. Thus, there is a continuing interest in developing new electrolyte-gated transistors.

In general, the fabrication of one-dimensional (1-D) nanomaterial-based electronic biosensors involves three distinct steps: (i) production of 1-D nanomaterials, (ii) merging 1-D nanomaterials into lithographically defined electrodes, and (iii) integration of electronic and microfluidic components. Great efforts are required during the post-production of 1-D nanomaterials incorporating those nanowires if they are to be used as functioning biosensors. There is a definite need for the development of much more convenient technologies.

Microfluidics technology is currently being used for various diverse applications, including chemical synthesis, separation, and diagnosis. Multilayer PDMS-based microfluidic systems possessing integrated valves and pumps have been developed to perform multiple functions within the same fluidic circuit. Recently, several groups have used micro-fluidics to fabricate nanomaterials such as silicon colloids and vesicles. Microfluidic environments can render biosensing tasks more efficient; for example, a microfluidic approach can require lower amounts of costly biological probes and can detect lower amounts of analytes than a traditional approach.

### SUMMARY OF THE INVENTION

In accordance with the present invention, a sensor is provided that is composed of an electrode pair made up of a first electrode having a first junction surface and a second electrode having a second junction surface. The first and second junction surfaces are located adjacent to each other to form a junction gap. As a feature of the present invention, a junction material is located in the junction gap. The junction material is composed of a network of conducting polymer nanowires (nanoframework) that extends between the junction surfaces to provide an electrically conductive connection (junction) between the first and second electrodes. Changes in the conductance of the junction due to interactions with analyte provide the basis for sensor operation.

As a feature of the present invention, the nanoframework is formed by filling the junction gap with a solution that includes a pre-polymer of the conducting polymer. An electrical current is then applied between the first and second electrodes in order to polymerize the pre-polymer to form a junction between the first and second electrodes that is composed of a network of conducting polymer nanowires.

As a further feature of the invention, an electrolyte gate composed of an electrolyte and a gate electrode is provided at the junction to convert the two-terminal sensor into a three-terminal field-effect transistor sensor. Both the two and three-terminal sensors in accordance with the present invention are well suited for use in forming arrays of multiple sensors. By selecting different pre-polymers and applying electrical currents selectively to the various electrode pairs, it is possible to form a large variety of junctions that can be used to simultaneously detect a correspondingly large number of targets in any given gas or liquid media.

As a further feature of the invention, an array of Pt working microelectrodes (each electrode separated by a 2 μm wide gap from another electrode in a pair of electrodes) and a single platinum counter electrode can be positioned within a microchannel of an overlaying two-layer polydimethylsiloxane (PDMS) microfluidic component to form a microfabricated and assembled integrated microfluidic device. The reference electrode is located just downstream of the working electrodes. We fabricated this microfluidic chip by soft-lithography from the PDMS A/B precursors (PDMS A/B precursors of General Electric). The input channels can be used to deliver both the monomer precursor solution for nanowire growth and the analyte solution for nanowire sensing. Pressurized control lines can be used to select from among the input solutions. The widths and heights of the channels can be 100 and 16 μm, respectively. Standard photolithography techniques can be used to fabricate platinum and gold microelectrodes on a silicon wafer possessing a thermally grown oxide layer. A solution of pyrrole or aniline monomers can be delivered to the electrode junctions, one electrode on either side of the junction served as the working electrode for the electropolymerization. The nanowires can be more rapidly grown to form the junctions within a microfluidic configuration than they can be conventionally grown in a bulk solution. For example, within a microfluidic junction chamber, the nanowires can be grown to form the junction within from about 5 minutes to about 30 minutes. For example, a microfluidic junction chamber can have the following dimensions: a width of at least 50 μm, e.g., a width of from 50 μm to about 500 μm, and a height of from about 5 μm to about 100 μm, e.g., a height of from about 5 μm to about 50 μm. For example, the distance between an electrode and a counterpart electrode of an electrode pair can be from about 1 μm to about 100 μm; for example, the distance between an electrode and a counterpart electrode of an electrode pair can be about 2 μm.

When the nanowires are grown within a microfluidic configuration, the diameters of the nanowires can be more uniform, and the orientation of the nanowires can be more uniform than of nanowires grown in bulk solution. For example, the nanowires can have a more uniform diameter, of about 50 nm. For example, the nanowires can be more parallel to each other, and have a tighter distribution of orientation centered about the direction pointing from one electrode to the other. By producing the network of nanowires to form the junction in a microfluidic environment, the prepolymer from which the nanowires are formed can be conserved. For example, the junction can be formed by a network of nanowires in a microfluidic junction chamber with 2 to 3 orders of magnitude less of prepolymer than when a comparable junction is formed by a network of nanowires in bulk solution. The network of nanowires forming the junction can be formed in a microfluidic junction chamber with prepolymer being forced to flow through the chamber, for example, by a differential pressure across the chamber of 2 psi, or without prepolymer being forced to flow through the chamber.

The present invention provides a template-free, site-specific and scalable electrochemical method for the fabrication of individually addressable conducting polymer nanoframework electrode junctions in a parallel-oriented array. These conducting polymer nanoframeworks, which are composed of numerous intercrossing conducting polymer nanowires, can be used for the chemical sensing of both gases and liquids.

Thus, the new approach presented in this application can simplify and consolidate the steps of producing 1-D nanomaterials, merging 1-D nanomaterials into lithographically defined electrodes, and integrating electronic and microfluidic components into one. An individually addressable array of conducting polymer nanowires (CPNWs) positioned within an integrated microfluidic device can be electrochemically fabricated in situ. Such an array of CPNWs within an integrated microfluidic device can be used as a chemical sensor immediately after its construction.

There are certain key advantages to preparing CPNWs within a microfluidic device using spatially localized, template-free electrochemical polymerization: (i) the monomeric precursor polymerizes directly on the electrode surface, producing high-quality ohmic contacts; (ii) addressability is inherent to this method because nanowires can be grown across individual electrode junctions; (iii) the introduction and delivery of small amounts of precursor monomers and analytes is highly controllable and enables the rapid exchange of a few microliters of solution on the chip; (iv) the diffusion-limited transport of the precursor within a microchannel can have a positive effect on the formation of nanowires during the electropolymerization process; and (v) once the nanowires are grown, the entire nanowire/microfluidics circuit is ready for use, without the necessity of any additional processing.

The above discussed and many other features and attendant advantages of the present invention will become better understood by reference to the detailed description when taken in conjunction with the accompanying drawings.

### BRIEF DESCRIPTION OF THE DRAWINGS

FIG. 1 is a diagrammatic representation of an exemplary sensor device in which 10 pairs of electrodes are connected together by a conducting polymer nanowire network junction (sensing element) that has been electrochemically grown in accordance with the present invention.

FIG. 2 is a detailed view of one of the conducting polymer nanowire network junctions shown in FIG. 1.

FIG. 3 is a diagrammatic representation of an exemplary three-electrode (field effect transistor) sensor device in accordance with the present invention.

FIGS. 4a and 4b are graphic representations of the results of testing of devices set forth in Example 6 using a positive gate voltage in aqueous 1.0 M NaCl media at different values of pH. FIG. 4a is a plot of pH-dependent on/off current ratios for exemplary nanoframework devices and comparative thin film and blank devices. FIG. 4b is a plot of pH-dependent field-induced charge mobilities for exemplary nanoframework devices and comparative thin film and blank devices.

FIG. 5 is a diagrammatic representation of an exemplary saccharide sensor that utilizes a conducting polymer nanowire network junction that has been grown electrochemically in accordance with the present invention.

FIG. 6 is a diagrammatic representation of an exemplary DNA sensor that utilizes a conducting polymer nanowire network junction that has been grown electrochemically in accordance with the present invention.

FIG. 7 is a plan view of a microfluidic device with integrated electrodes in contact with a junction chamber which can contain a conducting polymer nanowire network junction in accordance with the present invention.

FIG. 8 is a perspective view of a junction chamber in a microfluidic device in accordance with the present invention.

FIG. 9 is a graphic representation depicting the change in resistance of conducting polymer nanowires with time upon exposure to analytes of varying pH.

### DETAILED DESCRIPTION OF THE INVENTION

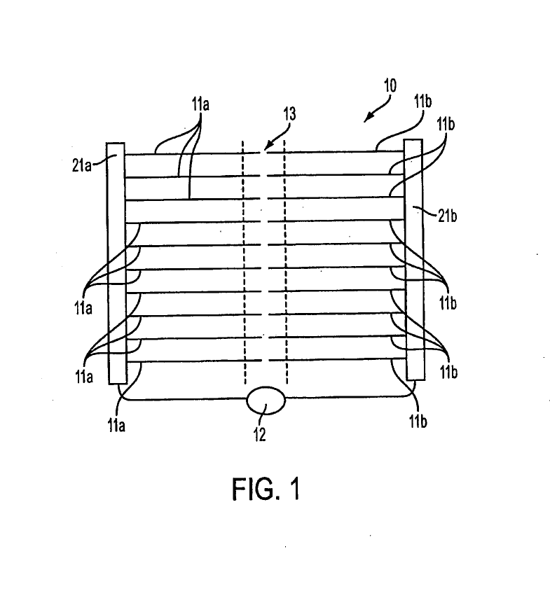

An exemplary sensor array in accordance with the present invention is shown at 10 in FIG. 1. The sensor array 10 includes ten electrode pairs made up of first electrodes 11a and second electrodes 11b. The electrodes 11a are electrically attached together via an electrode pad 21a, which is connected to potentiostat 12 or other suitable electrical device that is capable of measuring and generating electrical current/potential. Likewise, electrodes 11b are joined together electrically and connected to the potentiostat 12 via electrode pad 21b. All of the electrode pairs 11a and 11b are separated by a small junction gap shown at 13, which is filled with a network of conducting polymer nanowires.

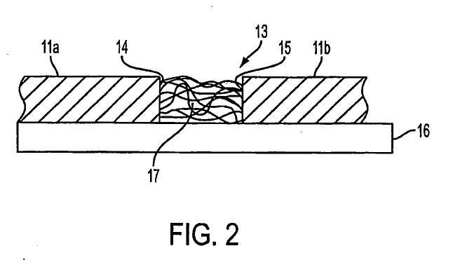

Referring to FIG. 2, a magnified diagrammatic cross-sectional view of the junction gap 13 is shown for a single electrode pair. The electrode 11a may be described as a first electrode having a first junction surface 14. The electrode 11b is a second electrode having a second junction surface 15. The electrodes are located on a suitable non-conducting substrate 16. The first and second junction surfaces 14 and 15 are located adjacent to each other to form the junction gap 13. In accordance with the present invention, a junction 17 is formed by a conducting polymer nanowire network (nanoframework) that is located in junction gap 13. The junction 17 provides an electrically conductive connection between the first and second electrodes. The junction functions in the same manner as other junctions used in resistive-type sensors.

The conducting polymer nanowire network is formed by filling the junction gap with a solution that contains a pre-polymer of the desired conducting polymer. As set forth in the Examples below, exemplary conducting polymers include polyaniline, polypyrrole and poly(ethylenedioxythiophene) (poly(EDOT)). Exemplary pre-polymers include monomers of the desired conducting polymers, as also set forth in the following Examples. The pre-polymer is polymerized to form the desired nanowire by applying a sufficient electrical current between said first and second electrodes for a sufficient time to polymerize the pre-polymer to form a junction between said first and second electrodes that comprises a network of conducting polymer nanowires. What constitutes a “sufficient” current and “sufficient” time will depend upon the particular conducting polymer nanowires that are being formed. The following examples provide exemplary currents and times that may be used as a guide in establishing what currents and times are required to form the desired conducting polymer nanowire networks. An initially high current (e.g. 50 nA) can be applied for a period of time to form polymer nuclei on the electrode surfaces. This initial nuclei formation can be followed by the application of lower electrical currents to the solution which provides for the electrochemical growth of the conducting polymer nanowires. The electrical current can be applied until a network of conducting polymer nanowires forms that extends between the two electrode surfaces and provides an electrical connection across the junction gap.

The various dimensions of the nanowires and junction gap spacing can be varied depending upon the particular materials that are used and the intended sensor application. For example, the junction gap between the electrodes can be from about 1 micron to about 100 microns; the junction gap between the electrodes can be from about 2 microns to about 100 microns. For example, the junction gap can be from about 1 micron to about 10 microns, or the junction gap can be from about 10 microns to about 15 microns. The junction gap between the electrodes can be from about 10 microns to about 100 microns, or the junction gap can be of another distance. For example, the electrodes can be from about 20 nm to about 500 nm thick; the electrodes can be from about 30 nm to about 100 nm thick. For example, the electrodes can be about 40 nm thick. For example, the electrodes can be from about 10 nm to about 100 microns wide; the electrodes can be from about 50 nm to about 10 microns wide. The nanowires that are grown in the junction gap should be at least as long as the gap. The diameters of the nanowires can be from about 30 nm to about 200 nm. For example, polyaniline nanowires can have diameters of from about 30 nm to about 200 nm; polyaniline nanowires can have diameters of from about 50 nm to about 200 nm. For example, polypyrrole and poly(EDOT) nanowires can have diameters of from about 30 nm to about 200 nm; polypyrrole and poly(EDOT) nanowires can have diameters of from about 50 nm to about 100 nm.

Examples of practice are as follows:

### EXAMPLE 1

In this example, we describe the use of electrochemical polymerization, at low and constant current levels, to fabricate, simultaneously and site-specifically, 10 conducting polymer nanoframework electrode junctions (CPNEJs; FIG. 1) in which a number of conducting polymer nanowires (CPNWs) of uniform diameter (for example, from about 40 nm to about 80 nm) intertwine to form nanoframeworks across a 2 μm gap between each pair of platinum (Pt) electrodes without the necessity of using any supporting template. In this example, the CPNWs are polyaniline nanowires. This example demonstrates that the present invention provides a highly efficient electrochemical process for the spontaneous and parallel fabrication of 10 CPNEJs in an array and that the resulting array can be used as a set of resistive junctions to demonstrate real-time electronic sensing in the gas phase and in solution.

For the fabrication of the CPNEJs, we applied a low-current electrochemical polymerization based on a well-established template-free method for producing polyaniline nanowires. Rather than growing the nanowires ubiquitously on the surfaces of the electrodes, we chose to prepare 10 CPNEJs simultaneously by growing 10 polyaniline nanoframeworks site-specifically from one set of electrodes to the other set of electrodes across 2 μm gaps. In principle, the number of CPNEJs of a junction array can be scaled up without limit by increasing the number and packing density of the electrodes. Additionally, all of the resulting CPNEJs can be produced simultaneously in a parallel fashion. Moreover, by addressing each individual junction electrochemically in a solution containing one specific monomer, a variety of conducting polymers can be introduced site-specifically into the conducting polymer nanoframework-electrode junctions to create an array containing a library of different conducting polymer nanoframework-electrode junctions.

A first conducting polymer nanoframework-electrode junction can be formed from a first monomer, and another conducting polymer nanoframework-electrode junction can be formed from another monomer, different from the first monomer, with the first conducting polymer nanoframework-electrode junction and the other conducting polymer nanoframework-electrode junction in the same array. For example, the first conducting polymer nanoframework-electrode junction can include polyaniline, and the other conducting polymer nanoframework-electrode junction can include polypyrrole or poly(ethylenedioxythiophene). Thus, the network of nanowires of an electrode pair can include a conducting polymer that is different from the network of nanowires of another electrode pair.

Alternative, the network of nanowires of each electrode pair in a sensor can include the same conducting polymer.

This approach should be highly efficient and scalable, while meeting the current requirements for nanoelectronics technologies, i.e., an integration of bottom-up production methods (electrochemical polymerization of nanoframeworks) and top-down fabrication (lithographic fabrication of Pt electrodes in an array).

FIG. 1 presents the electrode patterns we employed for the electrochemical production of the CPNEJs. We fabricated ten pairs of electrodes 11a and 11b (thickness: about 30 nm of Pt on 5 nm of titanium (Ti); width: about 10 μm; length: about 1000 μm) by standard photolithographic techniques and using electron beam deposition on a silicon (100) substrate covered with 500 nm of thermal oxide. The spacing between the parallel electrode pairs is about 100 μm and a 2 μm gap is located between the “fingertips” of each pair of electrodes. In addition, the set of ten electrodes were connected internally to millimeter-scale electrode pads 21a and 21b designated for attachment of wires. Before the fabrication of the CPNEJs, the electrode patterns were immersed in a piranha solution (70% conc. H₂SO₄/30% H₂O₂) for 2 min, rinsed with water, and then dried under a stream of N₂. Two sets of electrodes were then wire-bonded individually to the electrode pads for connection to a potentiostat (Princeton 263A) and to the measurement systems.

For example, the electrochemical production of the CPNEJ's can be performed using an aqueous solution containing from about 0.5 mM to about 500 mM aniline and 1.0 M HCl. For example, experiments were conducted with aniline at concentrations of 0.5 mM, 1.0 mM; 5 mM, 10 mM, 50 mM, 100 mM, and 500 mM. For example, we performed the electrochemical production of the CPNEJs using an aqueous solution containing 0.5 M aniline and 1.0 M HCl. We connected a standard three-port electrochemical configuration composed of working, counter, and reference electrodes as follows: the working electrode was connected to one set of electrodes having junction surfaces; the counter electrode was connected to a Pt coil; and the reference electrode was connected to an Ag/AgCl reference electrode. Another set of electrodes having junction surfaces were counterparts to the set of electrodes connected to the working electrode. This other set of electrodes was connected to ground.

The electrochemical process we employed for the production of the polyaniline nanoframeworks within the 2 μm gaps can be divided into three continuous steps. In the first step, a constant current (50 nA) was applied for about 30 min to introduce the polyaniline nuclei onto the Pt working junction electrodes. Under this relatively high current, the effective potential on the working electrodes remains at about 0.68 V (versus the Ag/AgCl reference electrode). It is essential to produce these initial electrode-based polyaniline nuclei because they serve as seeds for the growth of the nanoframeworks during the following two steps. In contrast, the use of a conventional cyclic voltammetry (CV) process results only in the formation on the electrode surface of homogeneous polyaniline thin films that lack any nanoscale features.

A scanning electron microscopy (SEM) image of a working junction electrode obtained immediately after the first electrochemical step was used to confirm the formation of the uniform polyaniline nuclei (diameters of from about 20 to about 80 nm). After this first step, the current was reduced to 25 nA while the effective potential dropped to 0.60 V (versus the Ag/AgCl reference electrode). During the second step (180 min), the polyaniline nanoframeworks began to propagate from the working junction electrodes to the other set of junction electrodes. Finally, the current was decreased to 12 nA, which led to an effective potential of 0.56 V.

After 180 min, the ten CPNEJs were obtained simultaneously in a parallel array with each polyaniline nanoframework positioned precisely within the 2 μm gap between its electrodes. We used SEM to characterize the morphology of the polyaniline nanoframework of each CPNEJ. The SEM micrographs showed that the nanoframeworks were composed of numerous intercrossing polyaniline nanowires that had diameters ranging from 40 nm to 80 nm. The correlation between the diameters of the polyaniline nanoframeworks and those of the nuclei suggests that these nanoframeworks are most likely grown from the nuclei. In addition, it should be noted that the electrochemical approach to the fabrication of CPNEJ arrays in accordance with the present invention is highly reproducible. For example, we have fabricated 36 CPNEJ arrays successfully from 38 attempts when using processes similar to the three-step electrochemical method described above. All of these 36 CPNEJ arrays were characterized by SEM and transport (I-V) studies. In these studies, we found that the resulting nanoframeworks in between each electrode junction had very regular dimensionalities (diameters of from about 40 nm to about 80 nm) and all of these arrays exhibited similar resistances ranging from 300 to 1000 Ω.

A test device can include a sensor according to the present invention. A detection unit can be coupled to the sensor, and a readout unit can be coupled to the detection unit. For example, a detection unit can be capable of determining the resistance between the first and second electrodes of a CPNEJ. The detection unit can be coupled to the sensor. For example, the detection unit can be coupled to the first and second electrodes; the detection unit can measure the current between the first and second electrodes when a voltage is imposed between the first and second electrodes, and/or the detection unit can measure the voltage between the first and second electrodes when a current is imposed between the first and second electrodes. The detection unit can be used with a sensor including only a single electrode pair, and can be used with a sensor including multiple electrode pairs, for example, including a first electrode pair and additional electrode pairs. For example, the first electrodes of a first electrode pair and one or more additional electrode pairs can be coupled to each other and to the detection unit; and the second electrodes of a first electrode pair and one or more additional electrode pairs can be coupled to each other and to the detection unit. Alternatively, the detection unit can be coupled to each of multiple electrode pairs in a sensor, without the electrode pairs being coupled to each other. For example, the first electrode of a first electrode pair and the first electrode of one or more additional electrode pairs can be coupled to the detection unit without the first electrodes being coupled to each other; and the second electrode of a first electrode pair and the second electrode of one or more additional electrode pairs can be coupled to the detection unit without the second electrodes being coupled to each other.

A readout unit coupled to the detection unit can display the results of measurements performed by the detection unit, for example, the resistance of a CPNEJ, to a user. Alternatively, the readout unit can amplify quantities measured by the detection unit for transmission to another electronic device, for example, the current flowing between the first and second electrodes or the voltage difference between the first and second electrodes can be proportionally amplified. Alternatively, the readout unit can transform quantities measured by the detection unit and transmit the transformed quantities to another electronic device. For example, the readout unit can proportionally convert the current flowing between the first and second electrodes, measured by the detection unit, to a voltage representative of the current, and transmit this representative voltage to another device. As another example, the readout unit can proportionally convert the voltage difference between the first and second electrodes, measured by the detection unit, to a current representative of the voltage difference, and transmit this representative current to another device. The readout unit can transform quantities measured by the detection unit to a digital format, and transmit the digital signal representative of the measured quantity to another device. For example, the readout unit can transform the current flowing between the first electrode and the second electrode to a digital signal, and transmit this digital signal to another device. As another example, the readout unit can transform the voltage difference between the first electrode and the second electrode to a digital signal, and transmit this digital signal to another device.

### EXAMPLE 2

In this Example, we used the CPNEJ arrays made according to Example 1 as miniaturized resistive sensors for the real-time detection of NH₃ (ammonia) and HCl (hydrogen chloride) gases and ethanol vapor. For all measurements in this example, which were performed at room temperature under ambient conditions using a Keithley 4200 semiconductor analyzer, a 0.1 V bias was applied across all of the CPNEJ's in the array and the change in resistance (log(R/R₀)), where R is time-dependent resistance and R₀ is the initial resistance, was monitored as a function of time. As a first part of this example, we demonstrated the detection of NH₃. A CPNEJ array was first doped in 1.0 M aqueous HCl prior to measurement. We measured the real-time change in resistance of an HCl-doped CPNEJ array upon exposure to NH₃ (100 ppm) dispersed in an ambient environment. We observed an increase in resistance by 1.2 orders of magnitude within 80 seconds as a result of the de-doping of polyaniline by NH₃. Because the de-doping of polyaniline by NH₃ is a reversible process, we demonstrated 10 cycles of the detection of NH₃ (0.5 ppm). This process, which occurs with high reproducibility, was performed by sequentially inserting and removing the CPNEJ array in and out of a container (1.0 L) filled with 0.5 ppm NH₃. Although the intensity of the response of the array toward NH₃ decayed with each detection cycle, we believe that this effect is due to a progressive decrease in the effective NH₃ concentration in the container because the example was conducted in an open system. For the detection of HCl, the same device was undoped by immersing the array in a 1.0 M NH₄OH solution. We measured the response of the resistance of the undoped CPNEJ array to HCl (100 ppm). We observed a change in resistance by four orders of magnitude within a response time of 5 seconds. The ability of these sensors to detect acidic and basic gases was found to be completely consistent with the results reported previously for other polyaniline-based sensors.

### EXAMPLE 3

In this example, CPNEJ arrays made according to Example 1 were used to detect a variety of organic vapors, including ethanol, methanol, chloroform and acetone. Initially, we demonstrated the reversible and reproducible response of the CPNEJ array to saturated ethanol vapor. The resistance of the nanoframework increased upon exposure to saturated ethanol vapor, we attribute this increase in resistance to the effect of swelling of the polyaniline backbone caused by the ethanol vapor. The effects of humidity and temperature have noticeable inferences to the absolute conductances (less than 10%) of these CPNEJ array sensors. Although these effects are negligible compared to the analyte-induced conductance changes, they still cause some perturbations in the realistic applications. In order to eliminate these humidity- and temperature-induced perturbations, the real-time responses of these CPNEJ array sensors to gases and vapor were expressed in the form of relative changes (R/R₀). In this case, the effects of humidity and temperature can be normalized so that these CPNEJ array sensors can be operated in ambient environment. At this point, it is important to note that the examples described herein were conducted in a research laboratory under a humidity of 50±5% and a temperature of 20±1° C.

### EXAMPLE 4

In this example, CPNEJ arrays made according to Example 1 were used as sensors of the acidity of aqueous solutions. To normalize the background conductance, we prepared 15 aqueous solutions having different values of pH, ranging from 0 to 14, from a 1.0 M NaCl solution. The presence of NaCl adjusts the total ion strength of the solutions and leads to the similar background conductances for all solutions. At the same time, a blank device with no polyaniline nanoframework in between the Pt junctions was used for measuring the conductance of the solution. The measurement was carried out by sequentially immersing the CPNEJ array and the blank device into solutions having increasingly higher values of pH (i.e., from 0 to 14). We measured the real-time response of the resistance of the array upon its immersion into the different solutions. The response can be divided into three distinct regimes: (1) a highly doped regime (pH 0-3), where we observed less than one order increase in resistance; (2) a high-response regime (pH 3-6) where the resistance response to pH changed dramatically (about 3.5 orders of magnitude), and (3) an undoped regime (pH>6), where the junction's conductance is small and is overwhelmed by the background conductance of the NaCl solutions. In contrast, the background conductances measured by the blank device remain the same for all 15 solutions. These results for pH sensing obtained using CPNEJ arrays in accordance with the present invention reflect to a great extent the resistance response of polyaniline to different values of pH that has been previously reported.

### EXAMPLE 5

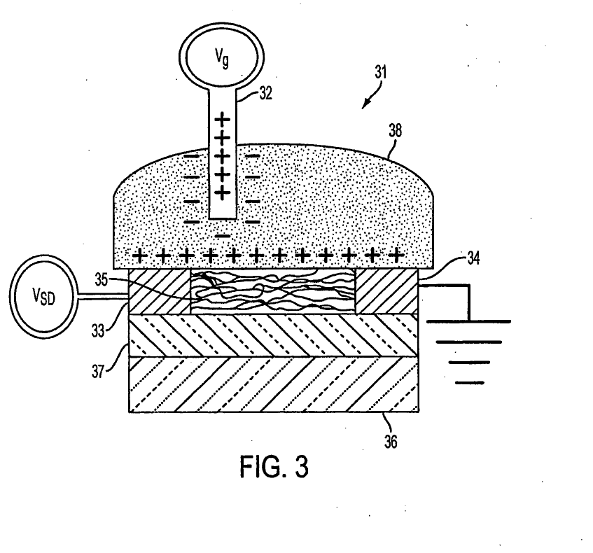

In the following example, we demonstrate the highly efficient electrolyte-gating and doping effects of a transistor based on CPNEJ's that are made in accordance with the present invention. A gate electrode and a gate medium (an aqueous medium (electrolyte)) of the transistor can together form an electrolyte gate. The transistors were made by immersing CPNEJs made according to Example 1 in a gate medium along with a gate electrode. The gate medium was a buffered electrolyte solution of 1.0 M NaCl. In parallel, we prepared comparative blank devices and FETs based on polyaniline thin films. The cross-section of the exemplary electrolyte-gated FET is graphically represented in FIG. 3 at 31. The FET 31 includes a Pt wire gate electrode 32, Pt drain electrode 33 and Pt source electrode 34. The conducting polymer nanowire network 35, doped silicon layer 36 and silicon dioxide layer 37 are the same as in Example 1. The aqueous medium (electrolyte) portion of the gate is shown at 38. The comparative FET's incorporating polyaniline thin films (thickness: about 50 nm) were fabricated by spin-coating polyaniline (Aldrich; MW 65,000) from a tetrahydrofuran (THF) solution (0.02 wt %) onto the blank devices.

Using a semiconductor analyzer (Kiethley 4200), we performed an initial characterization of the electrolyte-gated FET's in a buffered (pH 7.0) aqueous medium of 1.0 M NaCl at room temperature under ambient conditions. In general, both the drain and gate voltages were confined within the range from −0.8 to +0.8 to eliminate the electrochemical influence associated with the aqueous media. The linear drain current versus drain voltage characteristics of a polyaniline nanoframework-based FET were obtained as a function of different positive gate voltages. The value of linear drain current rises upon increasing positive gate voltage at a negative drain voltage, which indicates that holes are the major charge carriers (p-type character) in the polyaniline nanowires. It is important to note that we observed the value of drain current of the nanoframework-based FET's to be as high as 670 μA at a gate voltage of 0.8 V and drain voltage of −0.8 V. In contrast, a maximum of leakage current of 0.24 μA was observed for the comparative blank devices under otherwise identical measurement conditions. These results demonstrate that a leakage current is smaller than the drain current by a factor of 2800. It is totally negligible when it is taken into account with the value of the leakage current. In addition, we calculated the resulting on/off current ratio of the device from the drain currents at gate voltages of 0.8 V and 0 V to be 978. Within experimental error, this on/off current ratio is highly reproducible without any decrease upon repeatedly operating the FET's.

Under similar conditions, but applying a negative gate voltage, we observed a very weak gate modulation for the nanoframework-based FETs, which indicated that the n-channel transport mechanism does not function in these FETs in aqueous media at pH 7. We measured the drain current versus gate voltage at a constant drain voltage (−0.5 V) for the polyaniline nanoframework FET. We observed a reversible hysteresis for forward drain current and reverse drain current in the gate voltage range from −0.8 to +0.8 V. By considering the different regions of the drain current versus gate voltage curves, we calculated the average transconductance to be 28 μA/V, which is a larger value of average conductance than those of solid state FETs based on conducting polymer thin films. A large value of the transconductance also has been observed for electrolyte-gated single-wall carbon nanotube transistors. Our results in this example show that polyaniline nanowires are excellent p-type materials and that polyaniline nanoframework-based FETs should have large gate capacitance and high field-induced charge mobility.

The gate capacitance in an aqueous medium is a double-layer capacitance that can be calculated from the electrostatic capacitance between the nanowires and the surrounding ions. We calculated the gate capacitance for the FET's of this example to be 10 nF/m. This value is more than two orders of magnitude larger than the back-gated capacitance observed for solid state FETs. Such a large value of gate capacitance explains why we found such a large transconductance in the electrolyte-gated polyaniline nanoframework-based FETs of this Example.

The p-channel field-induced charge mobility in the linear region was calculated for the 10 parallel FETs and found to be 0.28 cm²/Vs at a constant drain bias (−0.5 V) in the 1.0 M NaCl electrolyte solution (pH 7). As a reference, the p-channel charge mobilities of polyaniline thin-film transistors have been reported to fall in the range of 1.4×10⁻⁴ to 0.01 cm²/Vs.

The comparative FET with a 50-nm polyaniline film was characterized under identical electrolyte-gated conditions. The maximum on/off current ratio was 156, the transconductance was 8.6 μA/V and the p-channel charge mobility at a constant drain voltage of −0.5 V was 2.6×10⁻⁴, which is close to that reported in the literature for solid-state polyaniline thin-film transistors.

### EXAMPLE 6

It is well known that polyaniline nanowires can be doped and dedoped by the actions of acid and base, respectively, which lead to dramatic changes in their transporting properties. In this example, we determined the relationship between the doped/dedoped transport properties and the field-induced modulation in transistors made according to example 5 and thin-film-based FET's using a series of aqueous media at different values of pH (ranging from 1 to 14). It is crucial to note here that the aqueous media contain 1.0 M NaCl to adjust for the ionic strength and ensure that similar background conductances are experienced by all of the FETs in the aqueous media. At the same time, we employed blank devices lacking either polyaniline nanoframeworks or thin films in the 2 μm wide drain-source channel as controls to monitor the background signals and the leakage current. The maximum leakage current that was observed was within the range of from 0.05 to 0.2 μA in aqueous media at pH of from 0 to 14. These values of leakage current are negligible when compared with the values of drain current observed for the exemplary polyaniline nanoframework FETs and the comparative thin-film FETs.

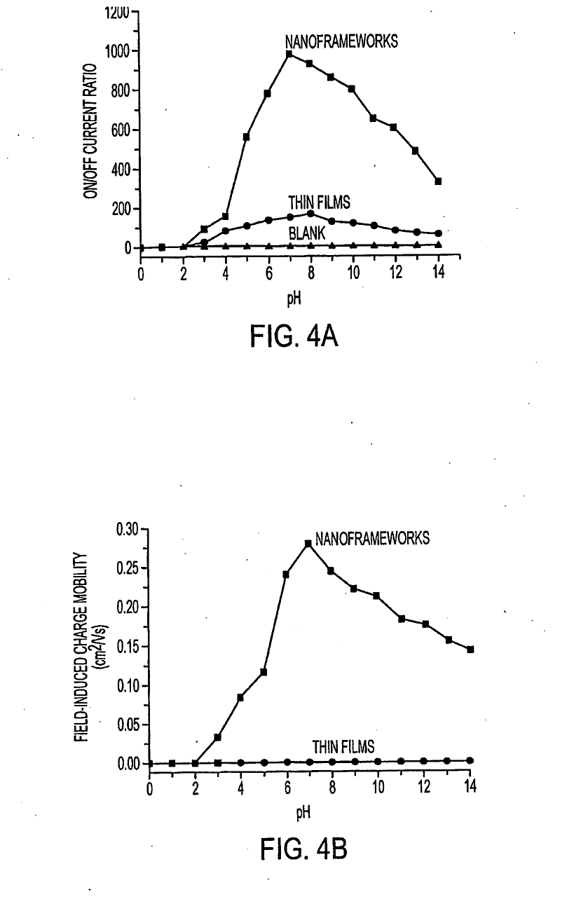

For the polyaniline nanoframework FETs, in the aqueous media having values of pH in the range from 3 to 14, we observed a positive gate voltage-induced modulation of drain current upon performing a negative sweep of drain voltage from 0.0 to −0.8 V. No transistor behavior was observed at pH 2 or below. We observed similar trends in the on/off current ratios and field-effect charge mobility for the control FET's, but with lower magnitudes in the field-induced properties. FIGS. 4a and 4b summarize the results we observed for the polyaniline nanoframework-based FETs and the comparative devices (thin-film and blank devices). The FET characteristics in response to the values of pH of the gate media can be divided into three distinct regimes: (1) a highly doped conductor regime (pH of from 1 to 2) in which no FET properties were observed because the highly doped polyaniline exhibits an ohmic behavior; (2) a medium-doped p-type semiconductor region (pH of from 3 to 7) in which the FET on/off current ratios (FIG. 4a) and field-induced charge mobilities (FIG. 4b) increase upon increasing the value of pH; and (3) a dedoped p-type semiconductor regime (pH greater than 7) in which the on/off current ratios and the field-induced charge mobilities decrease upon increasing the value of pH. At all values of pH, the on/off current ratios and the field-induced charge mobilities of the polyaniline nanoframework-based FETs in accordance with the present invention are 5 to 7-fold better and over three orders of magnitude larger, respectively, than those of the polyaniline thin-film-based FETs.

In basic gate media (pH greater than 9), we observed a negative gate-modulated transistor behavior for both the exemplary polyaniline nanoframework FETs and the thin-film-based FETs. At a gate voltage of −0.8 V and drain voltage of 0.8 V, the values of drain current fell in the range from 40 to 70 μA for the nanoframeworks and from 5 to 15 μA for the thin films. These values are a factor of 10 to 15-fold smaller than those observed for the positive-gated FETs. The on/off current ratios are 18 to 30 and we calculated the field-induced charge mobility at a drain voltage of 0.5 V to be from 0.04 to 0.06 cm²/Vs for the polyaniline nanoframework-based FETs in accordance with the present invention. These results demonstrate that the polyaniline nanowires can act as n-type semiconducting materials in basic media, but negative-gate modulation effects in the polyaniline-based FETs are less significant than the positive-gate modulation.

Through this example we have demonstrated electrolyte-gated and doped polyaniline nanoframework-based FETs using electrochemically fabricated CPNEJs in accordance with the present invention. We observed high-performance p-type FET characteristics at pH 7, including a large on/off current ratio (about 1×10³) and a high field-induced charge mobility (0.28 cm²/Vs). Because an ideal biosensor must function in neutral biological solution, e.g., phosphate-buffered saline (PBS) solution, the nanoframework-based FETs of the present invention are well suited for biological sensing applications.

In accordance with the present invention, a conducting polymer nanoframework-based two terminal resistive biosensor can be converted into a three-terminal biosensor by simply immersing the device into a biological solution alone with a gate electrode. In this case, the field-induced modulation can be applied for signal. amplification to enhance the sensitivity. In addition, it can provide another dimension of information along with the transport (current-voltage) characteristic obtained in the two-terminal device. context. Multiple FETs in accordance with the present invention can be formed in parallel with different conducting polymer nanoframeworks to provide a variety of individually addressable CPNEJs to provide ultra-sensitive, real-time, parallel detection of multiple analytes in biological systems.

A test device can include a sensor according to the present invention. A detection unit can be coupled to the sensor, and a readout unit can be coupled to the detection unit. For example, a detection unit can be capable of determining the on/off current ratio of an electrolyte-gate FET. The detection unit can be coupled to the sensor, for example, the detection unit can be coupled to the electrolyte gate, and can impose a potential on the electrolyte gate, and can be coupled to the first electrode and second electrode which function as the source and drain and measure the drain current. The detection unit can be used with a sensor including only a single electrode pair, and can be used with a sensor including multiple electrode pairs, for example, including a first electrode pair and additional electrode pairs. For example, the first electrodes of a first electrode pair and one or more additional electrode pairs can be coupled to each other and to the detection unit; the second electrodes of a first electrode pair and one or more additional electrode pairs can be coupled to each other and to the detection unit; and the electrolyte gates of a first electrode pair and one or more additional electrode pairs can be coupled to each other and to the detection unit Alternatively, the detection unit can be coupled to each of multiple electrode pairs in a sensor, without the electrode pairs being coupled to each other. For example, the first electrode of a first electrode pair and the first electrode of one or more additional electrode pairs can be coupled to the detection unit without the first electrodes being coupled to each other; the second electrode of a first electrode pair and the second electrode of one or more additional electrode pairs can be coupled to the detection unit without the second electrodes being coupled to each other; and the electrolyte gate of a first electrode pair and the electrolyte gate of one or more additional electrode pairs can be coupled to the detection unit without the electrolyte gates being coupled to each other.

A readout unit coupled to the detection unit can display the results of measurements performed by the detection unit, for example, the on/off current ratio, to a user. Alternatively, the readout unit can amplify quantities measured by the detection unit for transmission to another electronic device, for example, the drain current can be proportionally amplified. Alternatively, the readout unit can transform quantities measured by the detection unit and transmit the transformed quantities to another electronic device. For example, the readout unit can proportionally convert the drain current measured by the detection unit to a voltage representative of the drain current, and transmit this representative voltage to another device. As another example, the readout unit can transform the drain current to a digital signal, and transmit this digital signal to another device.

### EXAMPLE 7

An array incorporating both polypyrrole and poly(ethylenedioxythiophene) (poly(EDOT)) in place of polyaniline was made in the same manner as Example 1. The array included 40 finger-shaped Pt electrodes (width: 10 μm; thickness: about 30 nm of Pt on 5 nm of Ti) that were divided and interconnected to form four groups of electrodes (A, B, C and D). Twenty 2 μm wide gaps between the “fingertips” of the 40 junction electrodes were provided in the same manner as Example 1, such that electrode groups A and B were paired across 10 gaps and electrode groups C and D were paired across the other 10 gaps. The electrodes were also formed on a silicon (100) substrate covered with 500 nm of thermal oxide. Electrode groups A and C were wire-bonded to allow connection to a potentiostat (Princeton 263A). Typically, the electrochemical growth of the conducting polymer nanowires occurred in aqueous solutions containing 0.5 mN monomers (pyrrole or EDOT) and 0.1 M electrolyte (LiClO₄). A standard three-port electrochemical configuration was connected to one set of junction electrodes (electrodes A or C), a Pt coil and an Ag/AgCl reference electrode. The other sets of electrodes remained unconnected.

The polypyrrole nanowire framework junctions were fabricated first. In a pyrrole solution and with electrodes A connected to the working electrode of a potentiostat, we grew polypyrrole nanowires precisely from electrodes A, across the ten 2 μm wide gaps, to electrodes B by using a three step electrochemical process in the same manner as Example 1. First, a constant current of 80 nA was applied for 30 minutes, then 40 nA for 1.5 hour and finally 20 nA for 1.5 hour. No polypyrrole was deposited on electrodes C and D during this electrochemical process. Sequentially, the working electrode was connected to electrodes C and the pyrrole solution was replaced with an EDOT solution. Poly(EDOT) nanowires were then introduced onto electrodes C and D and between their ten 2 μm wide gaps by again using a three-step electrochemical process wherein a constant current of 50 nA was applied for 30 minutes, followed by a constant current of 25 nA for 1.5 hours and then a constant current of 12.5 nA for 1.5 hours. Through this process, we fabricated 10 polypyrrole-based and 10 poly(EDOT)-based conducting polymer nanoframework electrode junctions (CPNEJs) site-specifically in a parallel oriented array. In general, the poly(EDOT)-based CPNEJs exhibited resistances of around a few kΩ. The polypyrrole-based CPNEJs were less conductive and had resistances of about 10 kΩ.

The polypyrrole nanowires had extremely uniform dimensions (about 80-150 nm and several μm lengths). Similarly, the poly(EDOT) nanowires had very regular dimensionalities, with widths ranging from 60 nm to 120 nm. The array of polypyrrole and poly(EDOT) CPNEJs was used as a miniaturized resistive sensor for the parallel and real-time detection of organic vapors and gases. All of the measurements were performed at room temperature under ambient conditions using a semiconductor analyzer (Keithley 4200) equipped with its two individual measurement channels connected to the polypyrrole- and poly(EDOT)-based CPNEJs. We applied a 0.1 V bias across each set of CPNEJs and simultaneously monitored their changes in resistance as a function of time when each array was exposed to saturated ethanol vapor and was exposed to NH₃ gas. We observed highly sensitive responses (increase in resistance for both sets of CPNEJs) to the presence of ethanol vapor. We found that excellent specificity exists upon exposure of the polypyrrole- and poly(EDOT)-based CPNEJs to NH₃; that is, an increase in resistance for the polypyrrole CPNEJs was observed, but very little change for the poly(EDOT) CPNEJs was observed upon exposure to NH₃. In a comparative example, we tested a thin film-based sensor array fabricated using a conventional electrochemical polymerization process. This array exhibited a much slower response during sensing (two orders of magnitude slower). It should be noted that the signatures (sensitivity and specificity) observed in resistance changes of the CPNEJs can be utilized as fingerprints for the identification of a wide range of gas-phase analytes.

This example demonstrates that different conducting polymers can be used to form patterned electrode junctions, which provide individually addressable CPNEJs in a parallel-oriented array. In principle, the number of CPNEJs can be scaled up indefinitely by increasing the number and packing density of the electrodes to provide simultaneous analysis for numerous target analytes.

### EXAMPLE 8

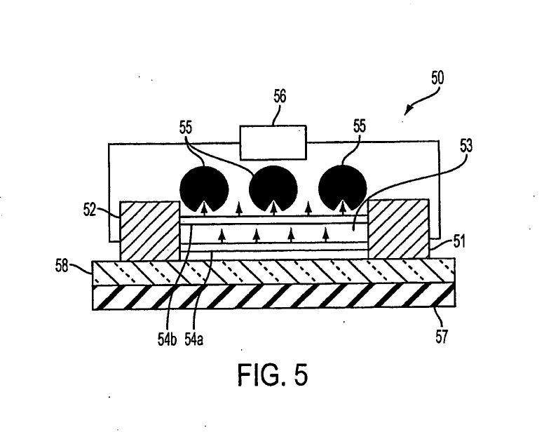

In addition to gas, vapor and pH sensing, sensors in accordance with the present invention may be used to provide resistive-based sensing of saccharide molecules in aqueous solution. A saccharide sensor was made in the same manner as Example 1 except that boronic acid-grafted polyaniline nanowires were deposited electrochemically between the 2 μm electrode junctions. The solution used to grow the nanowires was composed of aniline, 3-aniline boronic acid and electrolyte. The boronic acid group is well known as an excellent recognition motif for saccharides because of its very strong and specific binding affinity for two vicinal hydroxyl groups. The sensor is shown diagrammatically at 50 in FIG. 5. The sensor 50 includes junction electrodes 51 and 52, which are separated by junction gap 53. The boronic acid-grafted polyaniline nanowires are shown diagrammatically at 54a without any saccharide molecules being bound to the boronic acid moiety and at 54b with saccharide molecules 55 being bound to the boronic acid moiety. The sensor includes a conventional resistance measuring circuit 56 with the electrodes being deposited on a silicon/silicon dioxide substrate (silicon dioxide 58 layered on silicon 57) in the same manner as Example 1.

Using the sensor set up shown in FIG. 5, we measured the presence of a variety of saccharides (glucose, fructose and sucrose) in water as well as in buffered biological solution (phosphate-buffered saline) with sensitivities in the nM level.

### EXAMPLE 9

In this example, the same basic procedure used in Example 8 for detecting saccharides is applied to the detection of DNA. The sensor is made in the same manner as Examples 1 and 8, except that single-stranded DNA-grafted polypyrrole nanowires are electrochemically grown in the junction gap from an aqueous solution of pyrrole, single-stranded DNA-grafted pyrrole and electrolyte (LiClO₄). The junction conductance of this single-stranded DNA-grafted CPNEJ array responds dramatically to the presence of fluorescently tagged complementary DNA, such as Cy3-tethered complementary DNA. Detection sensitivities of up to 1.0 fM were observed. By incorporation of a third electrode (gate electrode) into this two-terminal DNA sensor, the resulting field-induced modulation can be used to enhance the sensitivity of this type of DNA sensor.

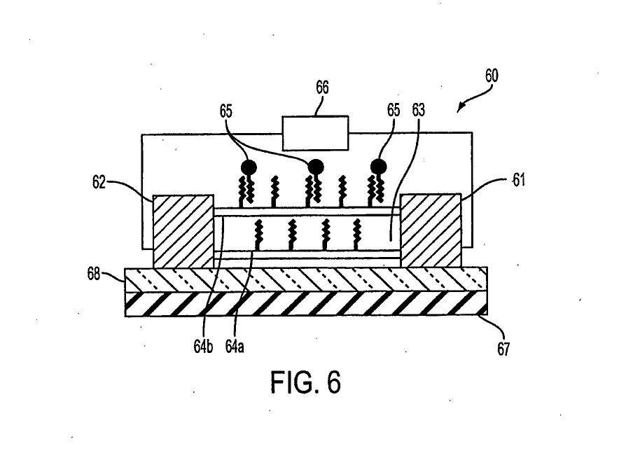

A DNA sensor in accordance with this example is shown diagrammatically at 60 in FIG. 6. The sensor 60 includes junction electrodes 61 and 62, which are separated by junction gap 63. The single-stranded DNA-grafted polyaniline nanowires are shown diagrammatically at 64a without any fluorescent-tagged complementary DNA molecules 65 being bound thereto and at 64b with the fluorescent-tagged complementary DNA molecules 65 being bound to the grafted single-stranded DNA moiety. The sensor includes conventional resistance measuring circuit 66 with the electrodes being deposited on a silicon/silicon dioxide substrate (silicon dioxide 68 layered on silicon 67) in the same manner as Example 1. If desired, different single-stranded DNA may be grafted to conducting polymer nanowires during growth of the wires in parallel junction gaps to provide for the detection of multiple complementary DNA.

### EXAMPLE 10

There are certain key advantages to preparing CPNWs within a microfluidic device using spatially localized, template-free electrochemical polymerization: (i) the monomeric precursor polymerizes directly on the electrode surface, producing high-quality ohmic contacts; (ii) addressability is inherent to this method because nanowires can be grown across individual electrode junctions; (iii) the introduction and delivery of small amounts of precursor monomers and analytes is highly controllable and enables the rapid exchange of a few microliters of solution on the chip; (iv) the diffusion-limited transport of the precursor within a microchannel can have a positive effect on the formation of nanowires during the electropolymerization process; and (v) once the nanowires are grown, the entire nanowire/microfluidics circuit is ready for use, without the necessity of any additional processing.

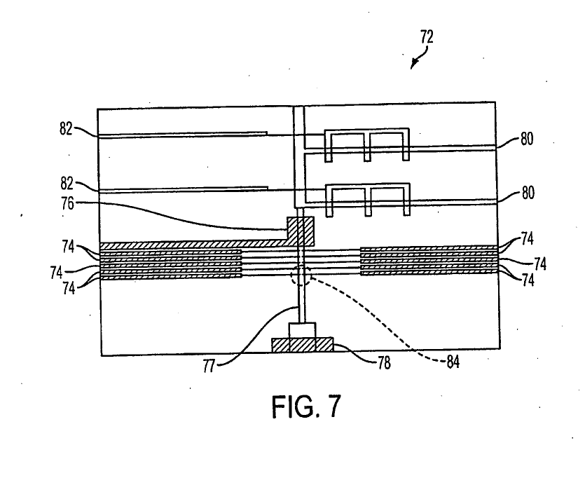

FIG. 7 presents a plan view of a microfabricated and assembled integrated microfluidic device 72. The device comprises an array of Pt working microelectrodes 74 (in a pair, each microelectrode 74 can be separated from its opposed counterpart microelectrode 74 by a 2 μm wide gap) and a single platinum counter electrode 76. A microelectrode 74 and its opposed counterpart microelectrode 74 form a pair of electrodes. One of the electrodes in an electrode pair serves as a working electrode. The microelectrodes 74 and counter electrode 76 are positioned within a central microchannel 77 of an overlaying two-layer PDMS microfluidic component. For example, in FIG. 7, the microelectrodes 74 on one side of the central microchannel 77 can serve as working electrodes; the microelectrodes 74 on the other side of the central microchannel 77 can, for example, be grounded. For example, one layer of the PDMS microfluidic component can include the central microchannel 77 and can include input channels 80, and another layer of the PDMS microfluidic component can include pressurized control lines 82. The reference Ag/AgCl electrode 78 is placed just downstream of the working electrodes. In the fabricated device shown in FIG. 7, the central microfluidic channel 77 is 16 μm high and 100 μm wide. The device shown included 5 pairs of electrodes; in each pair, an electrode 74 was separated from its counterpart electrode 74 by 2.0 μm. A pair of electrodes can be separated from an adjacent pair of electrodes by, for example, from about 10 μm to about 200 μm. For example, a pair of electrodes can be separated from an adjacent pair of electrodes by 100 μm. For each electrode 74 in the device illustrated in FIG. 7, the width was 10 μm and the height was 0.05 μm.

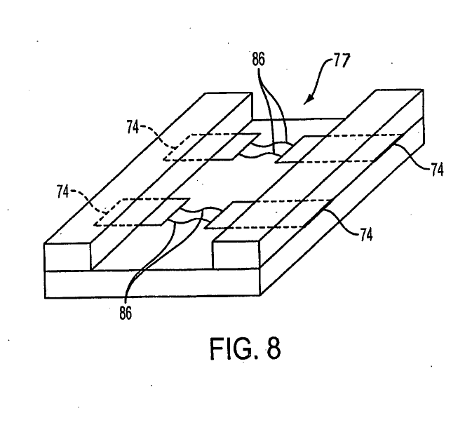

The input channels 80 can be used to deliver both the monomer precursor solution for nanowire growth and the analyte solution for nanowire sensing. Pressurized control lines 82 are used to select from among the input solutions. In manufacturing the device shown in FIG. 7, we used standard photolithography techniques to fabricate the platinum and gold microelectrodes on a silicon wafer possessing a thermally grown oxide layer. When a solution of pyrrole or aniline monomers was delivered to the electrode junctions, one electrode on either side of the junction served as the working electrode for the electropolymerization. FIG. 8 is a close up perspective view of a central microchannel 77 which serves as a junction chamber (the dashed circle 84 in FIG. 7 denotes the region which FIG. 8 shows in detail). The electrodes 74 contact fluid in the microchannel 77; in a pair of electrodes, an electrode 74 is located on one side of the microchannel 77, opposite the other electrode 74 located on the opposite side of the microchannel 77. After the conducting polymer nanowires 86 are grown, they can span the microchannel 77 between two electrodes 74, as shown. The resistance of a network of nanowires spanning the junction gap across the microchannel 77 between each electrode 74 of a pair of electrodes can be measured. The measured resistance can be used to make inferences about the nature of an analyte in contact with the conducting polymer nanowires 86.

We employed the galvanostatic current step method for the fabrication of the CPNWs. We first applied an initial current having a range of from 0.4 to 0.8 nA to the electrode for from 50 to 300 s, second reduced the current to a range of from 0.2 to 0.4 nA for from 500 to 1000 s, and third reduced the current further to a range of from 0.1 to 0.2 nA for from 500 to 1000 s. The precursor solutions we used were 0.5 M aniline in 1.0 M HCl and 0.02 M pyrrole in 0.1 M LiClO₄. We monitored the growth of the CPNWs by using optical microscopy and measured the conductance of the electrode junction periodically to assess the extent of polymerization.

We used scanning electron microscopy (SEM) to characterize the morphology of the polyaniline nanowires on the electrode surface. The nanowires, whose diameters ranged from about 50 nm to about 150 nm, covered the entire exposed area of the working electrode and bridged the gap of the junction between the electrodes. We believe that the polyaniline nanowires grew through a process of nucleation during the fast galvanostatic step and elongation during the subsequent steps. We performed this electropolymerization in the absence of any flow, but it may be possible to control the diameter and uniformity of the nanowires more precisely through careful manipulation of the flow rate. Relative to the morphology of polyaniline electropolymerized in a bulk solution, the nanowires that we grew in the microchannel were of much higher quality and fidelity; for example, the nanowires had a more uniform diameter. It is well established that carefully controlled nucleation of the monomer on the surface is critical for the growth of polymer nanostructures; fast nucleation and slow growth allow molecular reorganization and reorientation during the polymerization. The diffusion-limited nature of our electropolymerization at the electrode surface in a microchannel may, therefore, encourage the formation of the polyaniline nanowires.

CPNWs other than polyaniline nanowires may be produced using this technique. For example, polypyrrole nanowires were grown on an electrode surface within a microfluidic channel. The diameters of the polypyrrole nanowires ranged from about 50 to about 150 nm. The electropolymerizations of aniline and pyrrole both take about 30 min to produce nanowires that bridge the electrode gap in the microfluidic device. In bulk solution, however, this process requires almost 6 hours. The nature of our method and the architecture of our device allow the electrode array to be individually addressable and our method can be used to produce CPNW sensors having different compositions and a range of functions.

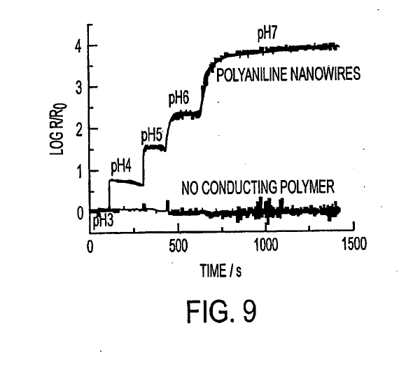

The conducting polymer nanowires can be used for sensing immediately after their fabrication within the microchannel. FIG. 9 presents the effect that pH has on the resistance of the polyaniline nanowires. We injected solutions of varying pH sequentially into the microchannel and recorded the change in resistance of the polyaniline nanowires using a Keithley 4200 analyzer. The resistance of the polyaniline nanowires increased logarithmically between pH 3 and 7, which is consistent with the transition of the polymer from the conducting emeraldine salt form to the insulating emeraldine base form. These polyaniline nanowires respond quickly to the changing pH of the solution; equilibrium was reached within a few seconds because of the high surface-area-to-volume ratio of the nanowires and the rapid exchange of the solution within the microfluidic chip. The time required for equilibration is significantly longer for nanowires grown in the bulk solution. The control curve in FIG. 9, with no conducting polymer spanning the junction between the electrodes was recorded using a junction that had not been subjected to electropolymerization.

The approaches we describe of incorporating conducting polymer nanowire junctions into microfluidic devices can be used in the fabrication of high-density, individually addressable CPNW arrays for use in chemical and biological sensing. The integration of electropolymerization and microfluidic techniques provides several important advantages that allow the simple and rapid fabrication of high-quality CPNW sensors and their immediate utilization in situ.

As is apparent from the above examples, the present invention provides a template-free, site-specific electrochemical approach to the precise fabrication of individually addressable conducting polymer nanoframework electrode junctions in a parallel-oriented array. The number of junctions in an array can be scaled up indefinitely by increasing the number and packing density of the electrodes. In addition, a library of different polymer nanoframework electrode junctions can be incorporated into an array by addressing each individual junction electrochemically in the presence of a particular monomeric precursor. The present invention may be used to construct sensor arrays that incorporate a variety of polymer nanoframework electrode junctions for the real-time, parallel detection of a variety of analytes in both gas phase and in solution.

A method can include contacting the junction of a two terminal CPNEJ with a test medium and measuring the change in conductance of electricity across the junction when the junction is contacted with the test medium. For example, the junctions of several two terminal CPNEJs of a sensor can be contacted with a test medium. The change in conductance of electricity across individual junctions can be 30 measured. Alternatively, the change in conductance of the set of junctions of the sensor, of which the first electrodes are electrically coupled to each other and the second electrodes are electrically coupled to each other, can be measured.

A method can include contacting the junction of a three terminal electrolyte-gated FET with a test medium and measuring the on/off current ratio of the FET and/or measuring the field induced charge mobility of the FET when the junction is contacted with the test medium. For example, the junctions of several three terminal electrolyte-gated FETs of a sensor can be contacted with a test medium. The on/off current ratio and/or the field induced charge mobility of the individual FETs can be measured. Alternatively, the on/off current ratio and/or the field induced charge mobility of the set of FETs of the sensor, of which the first electrodes are electrically coupled to each other, the second electrodes are electrically coupled to each other, and the gate electrodes are electrically coupled to each other, can be measured.

An analytical arrangement can include a sensor with several two terminal CPNEJs. The several CPNEJs can include the same conducting polymer. The junctions of two or more different CPNEJs in the analytical arrangement can be contacted with different test media. For example, the analytical arrangement can include wells in a plate, one or more CPNEJs of the sensor can be in each well, various liquids, solutions, or gases can be introduced into the wells, and a detection unit coupled to the CPNEJs can measure the conductivity of the CPNEJs in each well for the purpose of analyzing the test media in each well. With such an analytical arrangement, a large number of different test media can be analyzed in parallel.

An analytical arrangement can include a sensor with several three terminal electrolyte-gated FETs. The several FETs can include the same conducting polymer. The junctions of two or more different FETs in the analytical arrangement can be contacted with different test media. For example, the analytical arrangement can include wells in a plate, one or more FETs of the sensor can be in each well, various liquids, solutions, or gases can be introduced into the wells, and a detection unit coupled to the FETs can measure the on/off current ratio and/or the field-induced charge mobility of the FETs in each well for the purpose of analyzing the test media in each well. With such an analytical arrangement, a large number of different test media can be analyzed in parallel.

An analytical arrangement can include a sensor with several two terminal CPNEJs. The junctions of the several CPNEJs can be contacted with the same test 30 medium. The junctions of two or more different CPNEJs in the analytical arrangement can include different conducting polymers. For example, the analytical arrangement can include wells in a plate, one or more CPNEJs of the sensor can be in each well, and the same test medium, for example, a liquid, solution, or gas, can be introduced into the wells. A detection unit coupled to the CPNEJs can measure the conductivity of the CPNEJs in each well for the purpose of analyzing the test medium. With such an analytical arrangement having two or more of the wells having different conducting polymers in the CPNEJs, the wells can measure different properties of the test medium, and/or can be optimized for different ranges of a given property of the test medium.

An analytical arrangement can include a sensor with several three terminal electrolyte-gated FETs. The junctions of the several FETs can be contacted with the same test medium. The junctions of two or more different FETs in the analytical arrangement can include different conducting polymers. For example, the analytical arrangement can include wells in a plate, one or more FETs of the sensor can be in each well, and the same test medium, for example, a liquid, solution, or gas, can be introduced into the wells. A detection unit coupled to the FETs can measure the on/off current ratio and/or the field-induced charge mobility of the FETs in each well for the purpose of analyzing the test medium. With such an analytical arrangement having two or more of the wells having different conducting polymers in the FETs, the wells can measure different properties of the test medium, and/or can be optimized for different ranges of a given property of the test medium.

The embodiments illustrated and discussed in this specification are intended only to teach those skilled in the art the best way known to the inventors to make and use the invention. Nothing in this specification should be considered as limiting the scope of the instant invention. All examples presented are representative and non-limiting. The above-described embodiments of the invention may be modified or varied, without departing from the invention, as appreciated by those skilled in the art in light of the above teachings. It is therefore to be understood that, within the scope of the claims and their equivalents, the invention may be practiced otherwise than as specifically described.

1. A sensor comprising:
a first electrode pair comprising:
a first electrode comprising a first junction surface; and
a second electrode comprising a second junction surface wherein said first and second junction surfaces are located adjacent to each other to form a junction gap; and
a junction located in said junction gap, said junction comprising a network of nanowires comprising a conducting polymer, said network providing an electrically conductive connection between said first and second electrode.

2. The sensor of claim 1 that further comprises
an electrolyte gate located at said junction of said first electrode pair.

3. A sensor according to claim 2 that further comprises:
at least one additional electrode pair comprising:
a first electrode comprising a first junction surface; and
a second electrode comprising a second junction surface wherein said first and second junction surfaces are located adjacent to each other to form a junction gap;
a junction located in said junction gap of said at least one additional electrode pair, said junction comprising a network of nanowires comprising a conducting polymer, said network providing an electrically conductive connection between said first and second electrode of said at least one additional electrode pair; and
an electrolyte gate located at said junction of said at least one additional electrode pair.

4. A test device, comprising:
a sensor according to claim 3;
a detection unit coupled to said sensor; and
a readout unit coupled to said detection unit.

5. A test device according to claim 4,
wherein said first electrodes of said first electrode pair and said at least one additional electrode pair are electrically coupled to each other and to said detection unit,
wherein said second electrodes of said first electrode pair and said at least one additional electrode pair are electrically coupled to each other and to said detection unit, and
wherein said electrolyte gates of said first electrode pair and said at least one additional electrode pair are electrically coupled to each other and to said detection unit.

6. A test device according to claim 4,
wherein said first electrodes of each said first electrode pair and said at least one additional electrode pair are electrically coupled to said detection unit,
wherein said second electrodes of each said first electrode pair and said at least one additional electrode pair are electrically coupled to said detection unit, and
wherein said electrolyte gates of each said first electrode pair and said at least one additional electrode pair are electrically coupled to said detection unit.

7. A sensor according to claim 3 wherein said network of nanowires of an electrode pair of said first electrode pair and said at least one additional electrode pair comprises a conducting polymer that is different from said network of nanowires of another electrode pair of said first electrode pair and said at least one additional electrode pair.

8. A sensor according to claim 3 wherein said network of nanowires of each electrode pair of said first electrode pair and said at least one additional electrode pair comprises the same conducting polymer.

9. A sensor according to claim 2 wherein said conducting polymer is selected from the group consisting of polyaniline, polypyrrole and poly(ethylenedioxythiophene).

10. A sensor according to claim 1, wherein said conducting polymer is selected from the group consisting of polypyrrole and poly(ethylenedioxythiophene).

11. A sensor according to claim 2 wherein said junction gap is from 1 to 100 μm wide.

12. A sensor according to claim 2 wherein said junction gap is from 2 to 100 μm wide.

13. (canceled)

14. (canceled)

15. (canceled)

16. (canceled)

17. (canceled)

18. A sensor according to claim 2 that further includes an analyte in contact with said junction.

19. A sensor according to claim 18, wherein said analyte is selected from the group consisting of ammonia, hydrogen chloride, ethanol, methanol, chloroform and acetone.

20. A sensor according to claim 18, wherein said analyte is selected from the group consisting of a saccharide molecule and a DNA molecule.

21. A sensor according to claim 18,
wherein said analyte comprises an aqueous solution, and
wherein said sensor responds to the pH of said aqueous solution.

22. A sensor according to claim 1 that further includes an analyte in contact with said junction, wherein said analyte is selected from the group consisting of a saccharide molecule and a DNA molecule.

23. A method for making a sensor comprising the steps of:
providing a first electrode pair comprising:
a first electrode comprising a first junction surface; and
a second electrode comprising a second junction surface wherein said first and second junction surfaces are located adjacent to each other to form a junction gap;
filling said junction gap with a solution comprising a pre-polymer of a conducting polymer; and
providing a sufficient electrical current between said first and second electrodes for a sufficient time to polymerize said pre-polymer to form a junction between said first and second electrodes that comprises a network of conducting polymer nanowires.

24. A method for making a sensor according to claim 23 that includes the additional step of providing an electrolyte gate at said junction of said first electrode pair.

25. (canceled)

26. (canceled)

27. (canceled)

28. (canceled)

29. A method comprising the steps of
providing a sensor according to claim 1;
contacting said junction present in said sensor with a test medium;
measuring the change in conductance of electricity across said junction when said junction is contacted with said test medium.

30. A method comprising the steps of:
providing a sensor according to claim 2;
contacting said junction present in said sensor with a test medium;
measuring the on/off current ratio of said first electrode pair when said junction is contacted with said test medium.

31. A method according to claim 30 wherein said test medium is a liquid.

32. A method according to claim 30 wherein said test medium is a solution.

33. A method according to claim 30 wherein said test medium is a gas.

34. A method comprising the steps of:
providing a sensor according to claim 3;
contacting said junctions of said first electrode pair and said at least one additional electrode pair present in said sensor with a test medium; and
measuring the on/off current ratio of said first electrode pair and said at least one additional electrode pair when said junctions are contacted with said test medium.

35. An arrangement comprising the sensor of claim 3,
wherein said first electrode pair and said at least one additional electrode pair comprise the same conducting polymer, and
wherein said junction of an electrode pair of said first electrode pair and said at least one additional electrode pair is in contact with a first test medium, and said junction of another electrode pair of said first electrode pair and said at least one additional electrode pair is in contact with another test medium different than the first test medium.

36. An arrangement comprising the sensor of claim 3,
wherein an electrode pair of said first electrode pair and said at least one additional electrode pair comprises a first conducting polymer, and another electrode pair of said first electrode pair and said at least one additional electrode pair comprises another conducting polymer different from said first conducting polymer, and
wherein said junction of each electrode pair of said first electrode pair and said at least one additional electrode pair are in contact with the same test medium.

37. A microfluidic device comprising:
a substrate having at least one microchannel for the transport of at least one fluid; and
the sensor according to claim 1,
wherein said first electrode bounds a portion of said at least one microchannel, and said second electrode bounds another portion of said at least one microchannel.

38. A microfluidic device comprising:
a substrate having at least one microchannel for the transport of at least one fluid; and
the sensor according to claim 2,
wherein said first electrode bounds a portion of said at least one microchannel, and said second electrode bounds another portion of said at least one microchannel.

39. A microfluidic device comprising:
a substrate having at least one microchannel for the transport of at least one fluid; and
the sensor according to claim 3,
wherein said first electrode of said first electrode pair bounds a first portion of said at least one microchannel, and said second electrode of said second electrode pair bounds a second portion of said at least one microchannel, and
wherein said first electrode of said at least one additional electrode pair bounds a first additional portion of said at least one microchannel, and said second electrode of said at least one additional electrode pair bounds a second additional portion of said at least one microchannel.

40. (canceled)

41. (canceled)

42. (canceled)

43. (canceled)

44. (canceled)

45. (canceled)

46. (canceled)
